(19) United States
(12) Patent Application Publication
(10) Pub. No.: US 2019/0197391 A1
(43) Pub. Date: Jun. 27, 2019

(54) HOMEOSTATIC PLASTICITY CONTROL FOR SPIKING NEURAL NETWORKS

(71) Applicant: Intel Corporation, Santa Clara, CA (US)

(72) Inventors: Gregory Kengho Chen, Portland, OR (US); Phil Christopher Knag, Portland, OR (US); Ram Kumar Krishnamurthy, Portland, OR (US); Raghavan Kumar, Hillsboro, OR (US); Huseyin Ekin Sumbul, Portland, OR (US)

(21) Appl. No.: 15/855,813

(22) Filed: Dec. 27, 2017

(51) Int. Cl. G06N 3/04; G06N 3/063; G06N 3/08

(52) U.S. Cl. CPC G06N 3/049; G06N 3/08; G06N 3/063

(57) ABSTRACT

Systems and methods may apply homeostatic plasticity control in a spiking neural network, such as at a neuron of a core of the spiking neural network. The neuron may receive input spike information and determine whether to activate an output spike at the neuron based at least in part on the input spike information and a bias value. The bias value may be set based on whether the neuron issued a previous output spike during a previous time period. The bias value may be updated based on whether the output spike was activated at the neuron. For example, in accordance with a determination to activate the output spike, the bias value may be decreased, and in accordance with a determination to not activate the output spike, the bias value may be increased.

### TECHNICAL FIELD

Embodiments described herein generally relate to spiking neural networks, and specifically to homeostatic plasticity control for spiking neural networks.

### BACKGROUND

A neuromorphic processor is a processor that is structured to mimic certain aspects of biological neuron structures (e.g., the human brain) and its underlying architecture, particularly its neurons and the interconnections between the neurons, although such a processor may deviate from its biological counterpart. A neuromorphic processor may be composed of many neuromorphic cores—each of which may represent one or more neurons of a neural network—that are interconnected via a network architecture such as a bus or routing devices, which may direct communications between the cores. The network of cores may communicate via short packetized spike messages sent from core to core. Each core may implement some number of primitive nonlinear temporal computing elements (e.g., neurons). When a neuron's activation exceeds some threshold level, it may generate a spike message that is propagated to a set of fan-out neurons, which may be in destination cores. The network then may distribute the spike messages to destination neurons and, in turn, those neurons update their activations in a transient, time-dependent manner.

One or more state variables that represent the neuron's activation level may be maintained for each neuron. In typical operation, the state variables experience a step change in response to the occurrence of a spike at the input or the output, which decays as a function of time in an exponential manner. Historically, neurons have been modeled using analog architecture, which was well-suited to modeling exponentially-decaying state variables. In digital neuromorphic architectures, modeling of an exponentially-decaying function presents a number of computational challenges.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a high-level diagram of a model neural core structure in accordance with some embodiments.

FIG. 2 illustrates an intrinsic homeostatic control loop in a neuron in accordance with some embodiments.

FIG. 3 illustrates example microarchitecture of a neuron block in accordance with some embodiments.

FIG. 4 illustrates a bias learning homeostasis circuit in accordance with some embodiments.

FIG. 5 illustrates a stochastic bias learning homeostasis circuit in accordance with some embodiments.

FIG. 6 illustrates a flowchart showing a technique for homeostatic plasticity control in a spiking neural network in accordance with some embodiments.

FIG. 7 is a block diagram illustrating an example of a machine upon which one or more embodiments may be implemented.

FIG. 8 is a block diagram of a register architecture according to one embodiment of the invention.

FIG. 9 is a block diagram illustrating both an exemplary in-order pipeline and an exemplary register renaming, out-of-order issue/execution pipeline according to embodiments of the invention.

FIG. 10 is a block diagram illustrating both an exemplary embodiment of an in-order architecture core and an exemplary register renaming, out-of-order issue/execution architecture core to be included in a processor according to embodiments of the invention.

FIGS. 11A-B illustrate a block diagram of a more specific exemplary in-order core architecture, which core would be one of several logic blocks (including other cores of the same type and/or different types) in a chip.

FIG. 12 is a block diagram of a processor that may have more than one core, may have an integrated memory controller, and may have integrated graphics according to embodiments of the invention.

FIGS. 13-16 are block diagrams of exemplary computer architectures.

FIG. 17 is a block diagram contrasting the use of a software instruction converter to convert binary instructions in a source instruction set to binary instructions in a target instruction set according to embodiments of the invention.

### DETAILED DESCRIPTION

Systems and methods for homeostatic plasticity control in a spiking neural network are described herein. Spiking neural networks (SNN) are gaining significant traction to perform cognitive tasks such as computer vision, speech recognition, etc. Neural networks typically exhibit low firing activity and small mean pairwise correlations. However, neurons in SNNs often suffer from irregular firing rates caused by multiple factors including poor network initialization, sudden bursts of spikes from fan-in neurons, etc. The effect is even more pronounced in excitatory-inhibitory (EI) type of networks where even a small disruption in firing activity leads to an unbalanced state. Irregular firing activity impacts the ability of an SNN to learn the features properly, which ultimately results in a loss of performance.

Homeostatic plasticity refers to neurons adjusting excitability based on activity (e.g., an input spike). Homeostatic plasticity control may be used to regulate the firing activities of neurons. Analogous aspects of homeostatic plasticity control have been found experimentally in biological neural networks. Different types of homeostatic plasticity may include compensatory changes in synaptic drive, a neuron's intrinsic excitability, etc. Synaptic drive scaling involves the increase or decrease of synapse weight values in order to balance a post-synaptic neuron's firing rate. Intrinsic homeostatic control involves alteration of a neuron's parameters in order to achieve a balanced firing rate. Synaptic scaling may be performed at per-synapse granularity, while intrinsic homeostatic control may be performed on a per-neuron basis. Large scale SNNs often have a large skewed ratio between the available neurons and total synaptic memory, which may be similar to biological neural networks. For example, a large scale SNN may have a ratio of 1:256 (Total number of neurons/Total number of synapses). Synaptic scaling implementation in such large scale SNNs may suffer from high area and power overheads. On the other hand, intrinsic homeostatic control is often less expensive to implement since it is done at per-neuron granularity. In an example, a neuromorphic computer may implement intrinsic homeostatic control through firing threshold regulation. For example, every neuron has a variable threshold and its value is adjusted in response to the neuron's firing rate. When a neuron is firing rapidly, its firing rate may be reduced by incrementing the threshold at every firing. Similarly, a dormant neuron may be made active by decrementing the threshold each time-step. This approach may require additional state bits for each neuron in order to support variable threshold values for every neuron.

The homeostatic plasticity control described herein leverages bias plasticity to perform intrinsic neuronal excitability control, while maintaining a fixed threshold. Biases may be used to shift activation functions. A bias may be initialized with a specified value, such as depending on the region a neuron is intended to operate. The bias may be a pre-computed fixed value, which may be adjusted during training of the neuron. The homeostatic plasticity control described herein uses on-die learning schemes to adjust the bias in a neuron to achieve balanced firing rates in neural networks. The learning schemes described herein may include lightweight compute functions (often increment and decrement), such that the area and power overheads are minimal. A learning scheme may be applicable to both directed (excitatory-inhibitory (EI), liquid state machines, etc.) and undirected neural networks such as restricted Boltzmann machines. A learning scheme described herein may include stochastic bias training to achieve higher precision in bias learning for a fixed bias length. A learning scheme described herein may exhibit significant area reduction when compared to threshold manipulation schemes. For example, a neural network with 16K neurons grouped in 64 cores with a fixed threshold of 16b, and with each neuron having 8b input, 8b control parameters, and 16b bias, using a learning scheme described herein may provide 33% savings in neuron state bits over the threshold manipulation scheme.

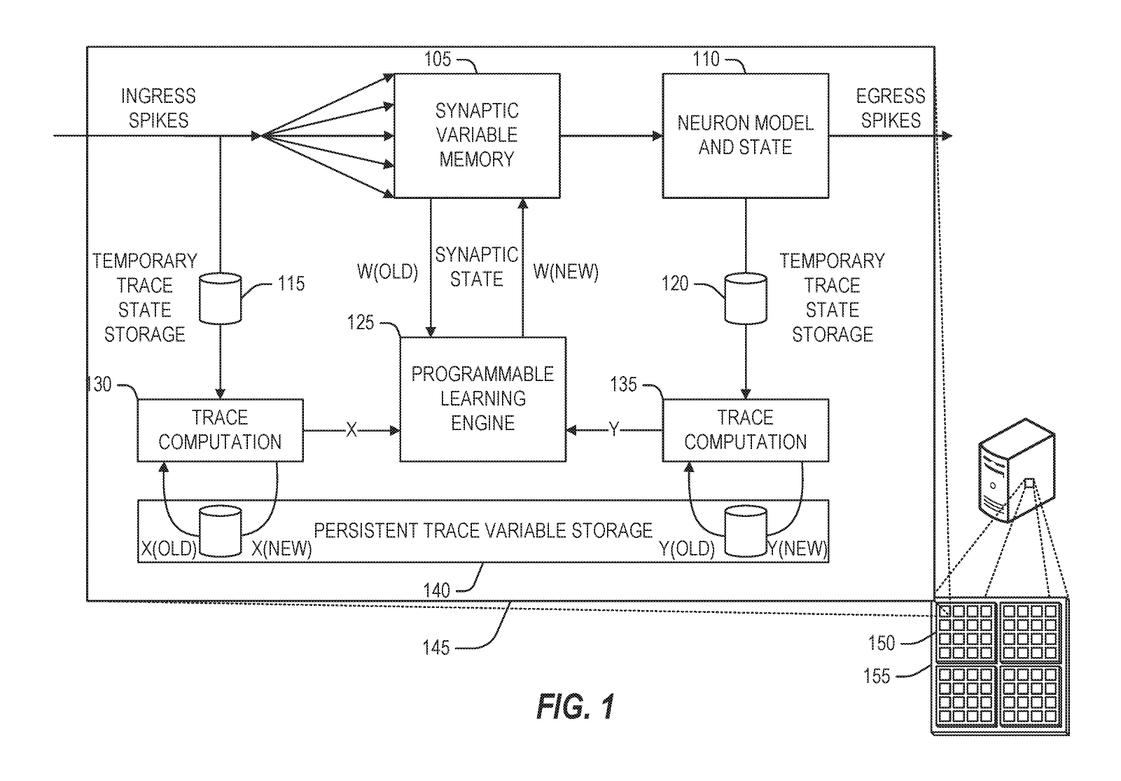

FIG. 1 is a high-level diagram of a model neural core structure, according to an embodiment. A neural core 145 may be on a die with several other neural cores to form a neural chip 150. Several neural chips may also be packaged and networked together to form the neuromorphic hardware 155, which may be included in any number of devices, such as servers, mobile devices, sensors, actuators, etc. The illustrated neural core structure functionally models the behavior of a biological neuron. A signal is provided at an input (e.g., ingress spikes) to a synapse (e.g., modeled by the synaptic variable memory 105) that may include a fan-out within the core to other dendrite structures with appropriate weight and delay offsets. The signal may be modified by the synaptic variable memory 105 (e.g., synaptic weights may be applied to spikes addressing respective synapses) and made available to the neuron model 110. The neuron model 110 may include a number of components to model dendrite activity and soma activity. In an example, the structures may include a dendrite accumulator and a soma state store. The neuron model 110 is configured to produce an output spike (e.g., egress spikes via an axon to one or several destination cores) based on weighted spike states.

In an example, a neuromorphic computing system may employ spike-timing-dependent plasticity (STDP) learning. Here, a network of neural network cores communicate via short packetized spike messages sent from core to core. Each core implements some number of neurons, which operate as primitive nonlinear temporal computing elements. When a neuron's activation exceeds some threshold level, it generates a spike message that is propagated to a set of fan-out neurons contained in destination cores. In managing its activation level, a neuron may maintain a trace variable that is incremented (e.g., as an impulse response) in response to a spike. Operations on the trace variable may model a number of time-dependent features. For example, following a spike, the trace variable may decay in an exponential manner. This exponential decay, modeled as an exponential function, may continue for a number of time steps, during which additional spikes may or may not arrive. Other example uses of the trace variable (e.g., spike trace storage) are discussed below.

To facilitate spike trace management, storage 115 may record temporary ingress spike information and storage 120 records temporary egress spike information. In addition, persistent trace variable storage 140 maintains trace information over time. The storages 115, 120, and 140 are used by the trace computation circuitries 130 and 135 (e.g., trace decay modelers) to provide updated ingress and egress traces for use by the learning engine 125. At a learning epoch event, such as the end of the epoch, the learning engine 140 uses the ingress trace X, egress trace Y. and the current synaptic weights W(old) to produce a new set of synaptic weights W(new). The new synaptic weights are then installed in the synaptic variable memory 105 to modify (e.g., weight) future ingress spikes, thus modifying the likelihood that a particular combination of ingress spikes causes an egress spike. Thus, the architectural role of the trace computation circuitries 130 and 135 is to maintain trace variable state X and Y respectively, in response to spike events either received as input to the core (ingress spikes) or produced by the neuron units 110 inside the core (egress spikes). Each spike event may generate temporary state for the trace computation that is accumulated over the duration of a periodic interval of time defined as the learning epoch. At the end of each learning epoch, the learning engine modifies synaptic variable state (W) as a function, in part, of the computed X and Y trace values.

The network distributes the spike messages to destination neurons and, in response to receiving a spike message, those neurons update their activations in a transient, time-dependent manner, similar to the operation of biological neurons.

The basic implementation of some applicable learning algorithms may be provided through spike timing dependent plasticity, which adjusts the strength of connections (e.g., synapses) between neurons in a neural network based on correlating the timing between an input (e.g., ingress) spike and an output (e.g., egress) spike. Input spikes that closely proceed an output spike for a neuron are considered causal to the output and their weights are strengthened, while the weights of other input spikes are weakened. These techniques use spike times, or modeled spike times, to allow a modeled neural network's operation to be modified according to a number of machine learning modes, such as in an unsupervised learning mode or in a reinforced learning mode.

The core may also support backwards-propagation processing. In biology, when the soma spikes (e.g., an egress spike), in addition to that spike propagating downstream to other neurons, the spike also propagates backwards down through a dendritic tree, which is beneficial for learning. The synaptic plasticity at the synapses is a function of when the postsynaptic neuron fires and when the presynaptic neuron is firing—the synapse knows when the neuron is fired. In a multi-compartment architecture, once the soma fires, there are other elements that know that the neuron fired in order to support learning, e.g., so all of the input fan-in synapses may see that the neuron fired. The learning engine 125 may implement spike timing dependent plasticity (STDP) and receive this backwards action potential (bAP) notification (e.g., via the trace computation circuitry 135) and communicate with the synapses 105 accordingly.

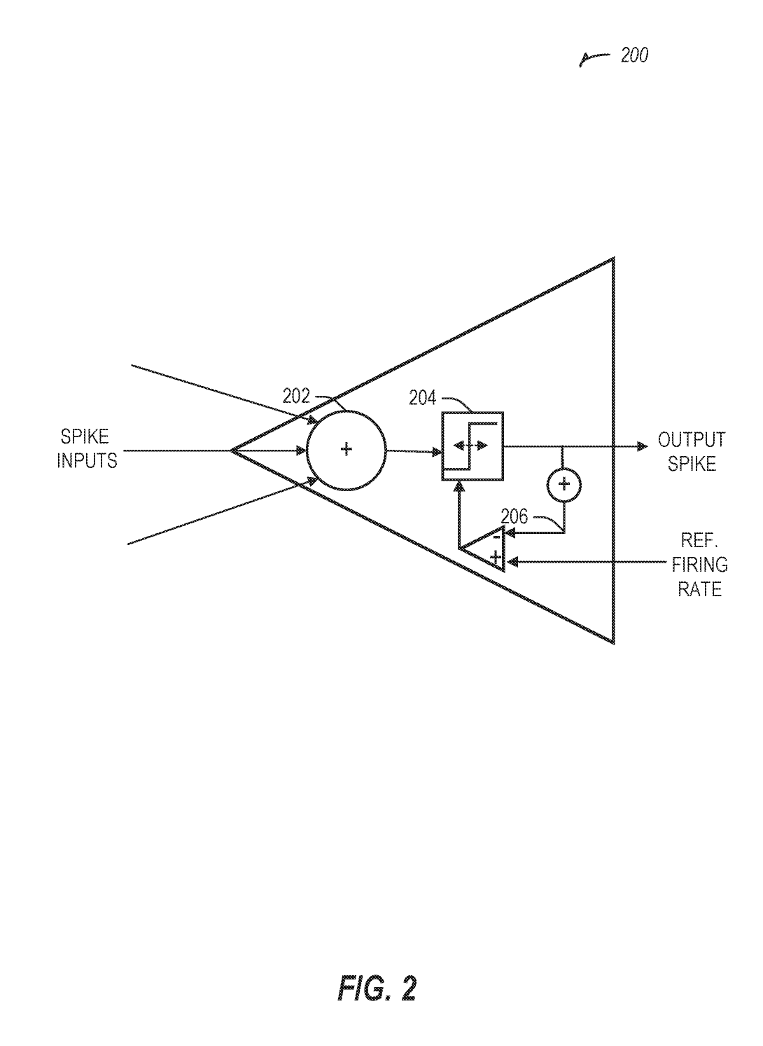

FIG. 2 illustrates an intrinsic homeostatic control loop in a neuron 200 in accordance with some embodiments. In an example, a group of neurons that suffer from imbalanced firing rates may be balanced and kept in an information-rich operating regime using various mechanisms. For example, synaptic scaling based homeostatic control may be used, but may be expensive to implement, for example in large-scale SNNs, such as those with a large synaptic memory. In an example, intrinsic neuronal excitability may be used over synaptic scaling due to intrinsic neuronal excitability having a reduced area cost of implementation. An example benefit of intrinsic homeostasis includes using only local communication within a neuron, while synaptic scaling involves communication across different portions of the network. Intrinsic homeostasis may be implemented as a negative feedback loop, for example with a rise in a firing rate of the neuron 200 leading to alteration of parameters of the neuron 200, such that the firing rate of the neuron 200 reduces.

As shown in FIG. 2, the neuron 200 integrates incoming weighted spikes (spike inputs) in its membrane potential 202, and applies a threshold function 204. In an example, when the membrane potential is greater than a threshold, the neuron 200 produces an output spike and resets the membrane potential. The negative feedback loop 206 uses the spiking rate of the neuron 200 and when the spiking activity exceeds a reference firing rate, the feedback loop 206 shifts the threshold function to the right (e.g., increasing the threshold). This may result in a decrease in the firing rate of the neuron 200. In an example, the threshold function may be shifted to the left (e.g., decreasing the threshold) when the firing rate of the neuron 200 is lower than the reference firing rate. In an example, the reference firing rate is a desired firing rate used to determine whether to shift the transfer function.

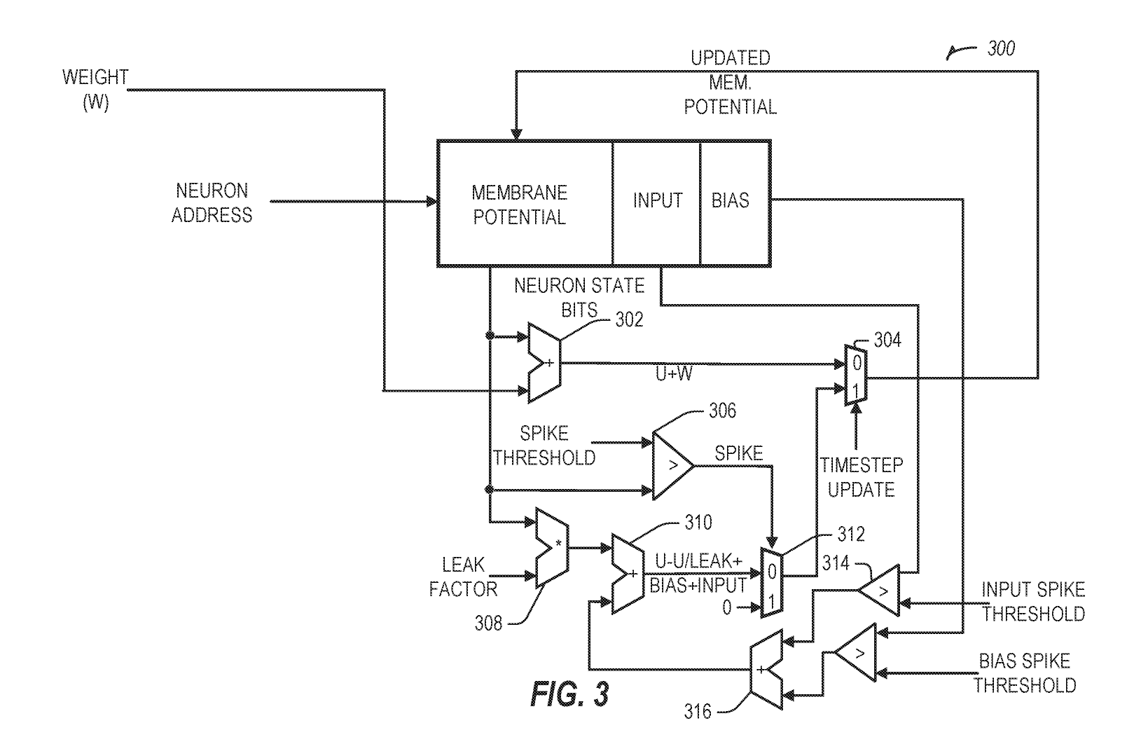

FIG. 3 illustrates example microarchitecture 300 of a neuron block in accordance with some embodiments. As discussed above, shifting a threshold function in a neuron may require extra bits for neuronal states. For example, every neuron may have a variable threshold such that the threshold is shifted based on its firing rate. In the example shown in FIG. 3, a lightweight homeostatic control scheme is used, where a neuron's bias value is learned in order to match a desired spike rate. The bias bits may already be available for a neuron (or for all neurons), and the homeostatic control scheme of FIG. 3 avoids needing additional neuron state bits. The microarchitecture of a neuron's data path is shown in FIG. 3. In an example, only the bias value related data paths are shown in FIG. 3. The neuron may have additional data paths not shown in FIG. 3, such as on-die synaptic weight learning, time-step control, etc.

The neuron block integrates incoming weights with a membrane potential at adder 302. The neuronal state bits may be stored in a memory (such as register files). A computational unit may be time-multiplexed across the neuron at a multiplexer 304. During a time-step, the neuron may undergo a thresholding operation at comparator 306. When the membrane potential is lower than the threshold, the neuron undergoes a leak operation at multiplier 308 (e.g., by decreasing the membrane potential by a pre-set leak factor). The input and bias values may be added to the membrane potential at adder 310. The membrane potential value may be updated in the state bit memory.

In an example, an input spike is generated at comparator 314, where the input value is compared to an input spike threshold. When the input exceeds the input spike threshold, the input spike is added to a bias at adder 316. The bias value may be compared to a bias spike threshold at comparator 318, to determine, for example, whether to output the bias to the adder 316. When the bias is less than the bias spike threshold, the bias may not be sent to the adder 316. Using the bias spike threshold, only a high enough bias may be sent through to the adder 316. The bias spike threshold may be selected by a user, adjusted based on past bias or spike information, generated using a pseudo-random number generator, or the like. The output of adder 316 is then sent to adder 310 for adding or subtracting the updated membrane potential from multiplier 308. The results are sent to the multiplexer 312, which is then saved as updated membrane potential (e.g., in a register).

Although the example shown in FIG. 3 uses a leaky neuron model, any neuron model may be used. The leak is a mechanism to give priority to more recent inputs (spikes), and gradually reducing impact of older inputs. Other SNN may include any neural network that relies on a membrane potential to determine whether to fire.

During a time step, all of the neurons in a particular block may act or spike, and then the neurons may move to a next time step. Logical neurons may be time multiplexed with a single computational block. For example, with 100 incoming neurons, spikes from the incoming neurons may be added at the neuron block until the time step ends. At this point, the register value may be retrieved, and when the incoming spike total value exceeds the threshold, then the neuron may fire an output spike. The output spike value may be fired in the next time step. When the neuron does not spike, then the neuron may leak the thresholds, increasing the likelihood of a spike. In an example, the incoming spike total value, the leak value, and the bias may be added, together, such as according to a Poisson based addition. For example, a random number may be generated, and the inputs (spike, leak, bias) may be compared to the random number. When the inputs are greater than random number, then the values are added with the state variable (membrane potential).

The input spike threshold may be a programmed value (e.g., may include a single threshold for all neurons, such as within a core) or the value may be empirical, with an initial value selected and adjusted throughout the training. The bias spike threshold may be empirical as well. For example, 100 time steps may be run for the neuron or the core, resulting in adding the bias value 64 times out of the 100 time steps. Then for future time steps, a random number may be selected and compared to 64. When the random number is greater than 64, then the bias is added, which adds stochasticity to the example microarchitecture 300. In another example, the bias (e.g., 64) may be added to each neuron without the stochastic determination.

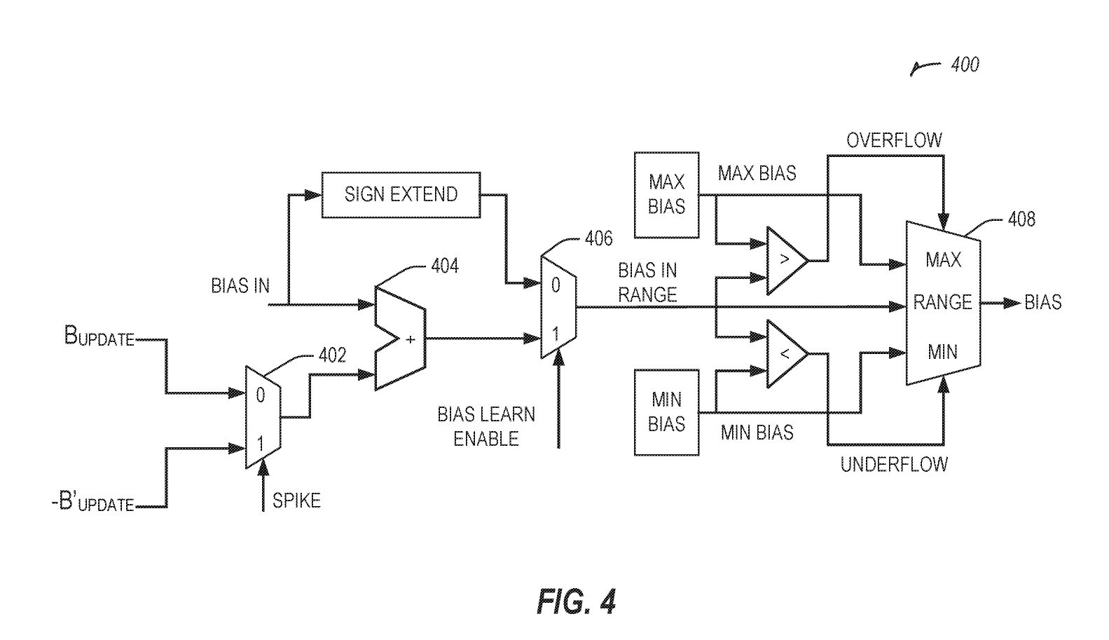

FIG. 4 illustrates a bias learning homeostasis circuit 400 in accordance with some embodiments. The bias learning homeostasis circuit 400 receives a bias input and outputs a bias output, by consulting a look-up table that includes an increment value B_{update} and a decrement value B′_{update}.

After a thresholding operation of a time-step, the bias value may be incremented by B_{update}, for example when there is no spiking activity (e.g., no spike output). Adding in the B_{update} increases the probability of the neuron spiking in a next time-step or future time-steps. On the other hand, when there is a spike output, the bias value may be decremented by B′_{update}. Reducing by B′_{update} lowers the spiking probability of the neuron spiking in the subsequent time-step or future time-steps. A desired spiking rate may be achieved by setting the bias update values such that they follow the following relationship:

N*B_{update}=B′_{update} Eq. 1

Based on this relationship, the desired spiking rate may be

$$\frac{1}{t + 1} ,$$

where t is a number of time-steps. For example, when the bias increment value is set to 1 and the bias decrement value is set to 32, the neuron is more likely to fire once for every 32 time-steps. Depending on the type of workload, the desired spiking activity may be set. The desired spiking activity may be set according to a learning activity performed at the neuron. For example, when input is high (many incoming spikes), without a bias, the neuron may spike too often, producing incorrect or undesirable results. Using the bias, the likelihood of spiking of the neuron may be decreased, even with the high input, ensuring that the neuron spikes according to the desired spiking activity. Similarly, when the input is low (few incoming spikes), the bias may be used to ensure that the neuron spikes enough to produce the desired spiking activity. The bias learning homeostasis circuit 400 may include a bounds-check to ensure that the learned bias value is within maximum and minimum bounds.

For example, multiplexer 402 outputs the B_{update} when there is no output spike and the B′_{update} when there is an output spike for a last time-step. The output of the multiplexer 402 is added to a previous bias value at adder 404. When the bias learning homeostasis circuit 400 is set to use the bias learning at a current time-step, the output of adder 404 may be output from multiplexer 406. The output of the multiplexer 406 may be compared to a minimum bias or a maximum bias to ensure that the value for a bias output is within a specified range. For example, in an 8-bit system, a minimum bias value may be −128 and a maximum bias value may be 127. When outside those ranges, the bias output may be set to the minimum or the maximum at multiplexer 408. The bias value may then be output.

The bias learning homeostasis circuit 400 outputs a bias that is directly proportional to spiking, whereas the thresholding of, for example, FIG. 3 is indirectly proportional to spiking. Thus, increasing the bias increases the likelihood of a spike output, and decreasing the bias decreases the likelihood of a spike output.

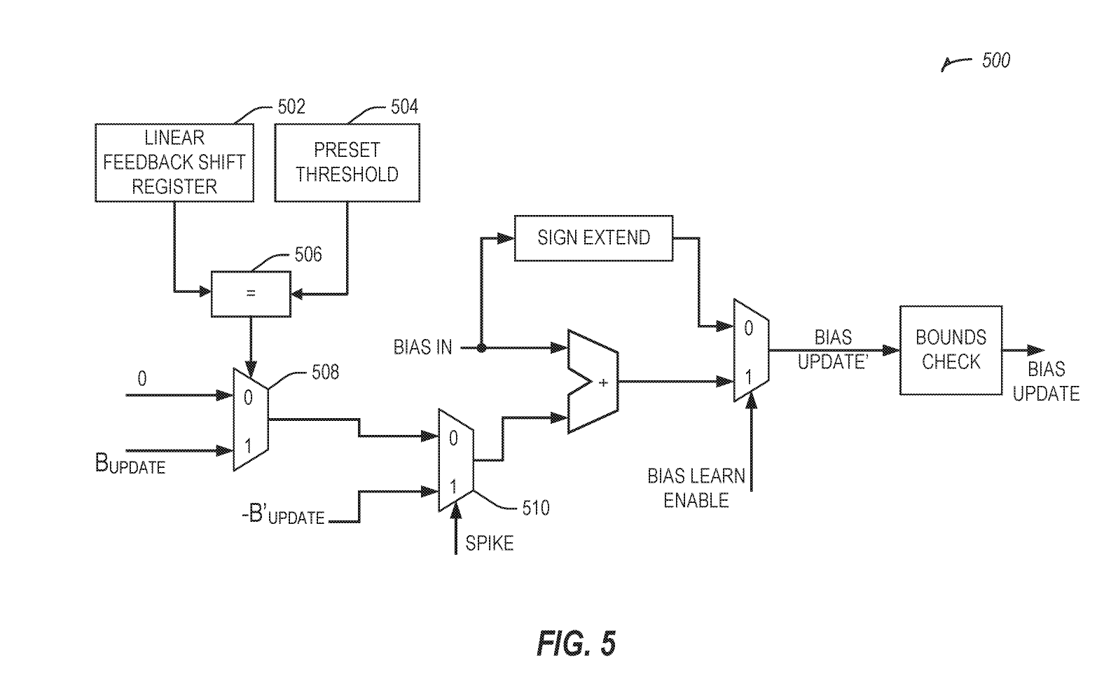

FIG. 5 illustrates a stochastic bias learning homeostasis circuit 500 in accordance with some embodiments. The stochastic bias learning homeostasis circuit 500 uses a pseudo-random number generator to adjust whether to add the B_{update} or subtract the B′_{update} to the bias value when updating the bias.

In order to increase the precision of the bias value while performing homeostasis plasticity control, the stochastic bias learning homeostasis circuit 500 may be used to increment or decrement the bias value in a probabilistic way. The precision may be dictated by the probability of the bias update value. The stochastic bias learning homeostasis circuit 500 includes a variable precision pseudo-random number generator (PRNG) 502, such as a Linear Feedback shift register (LFSR), which may allow for variable precision. The LFSR may be reconfigurable across a different number of maximal length polynomials (e.g., 2-bit, 8-bit, etc.). The random sequence generated by the LFSR may be compared against a preset threshold 504 by comparator 506. In an example, when the values are equal, the bias update value may be added to the bias value.

The precision of bias learning may be increased by an amount proportional to the length of the LFSR state value when output from comparator 506. For example, when the LFSR is configured in a mode to generate 8-bit random sequences, the bias update may occur with a probability of 1 in 255, because the LFSR may cycle through 255 sequences (2⁸-1).

In another example, the bias learning stochasticity may be controlled with a pseudo-random number generator (PRNG) 502 of fixed sequence length, and the bias may be updated when the PRNG 502 value exceeds a user defined value. In this example, the bias learning rate may be controlled from 0 to 1 in increments of 1 over the PRNG sequence length. Using the stochastic bias learning homeostasis circuit 500 increases the precision of bias learning without adding additional bits in the bias state. The LFSR may be shared across multiple neuron groups (e.g., in multiple neuron cores) by daisy-chaining the input and output bits of the shifting LFSR flip-flops at each core, thus saving area. In another example, each neuron may use its own LFSR or LFSR output. In an example, a single LFSR may be shared across all the cores, while in another example, each core may have its own LFSR, depending on the available hardware resources.

In the example shown in FIG. 5, the LFSR is compared to the present threshold 504. When equal, as determined at comparator 506, the B_{update} value is output from the multiplexer 508. When not equal, zero is output from the multiplexer 508. The next multiplexer 510 determines whether to output the B_{update} (when no output spike occurred at a previous time-step) or to output the B′_{update} (when an output spike occurred at a previous time-step). In this example, the decrement always occurs when the neuron spiked in the previous time-step. In another example, the decrement may include a stochastic operator to probabilistically adjust whether the decrement is used. After the output of multiplexer 510, the operations may continue, such as in FIG. 4, to output a bias value update (which may be subject to a bounds-check).

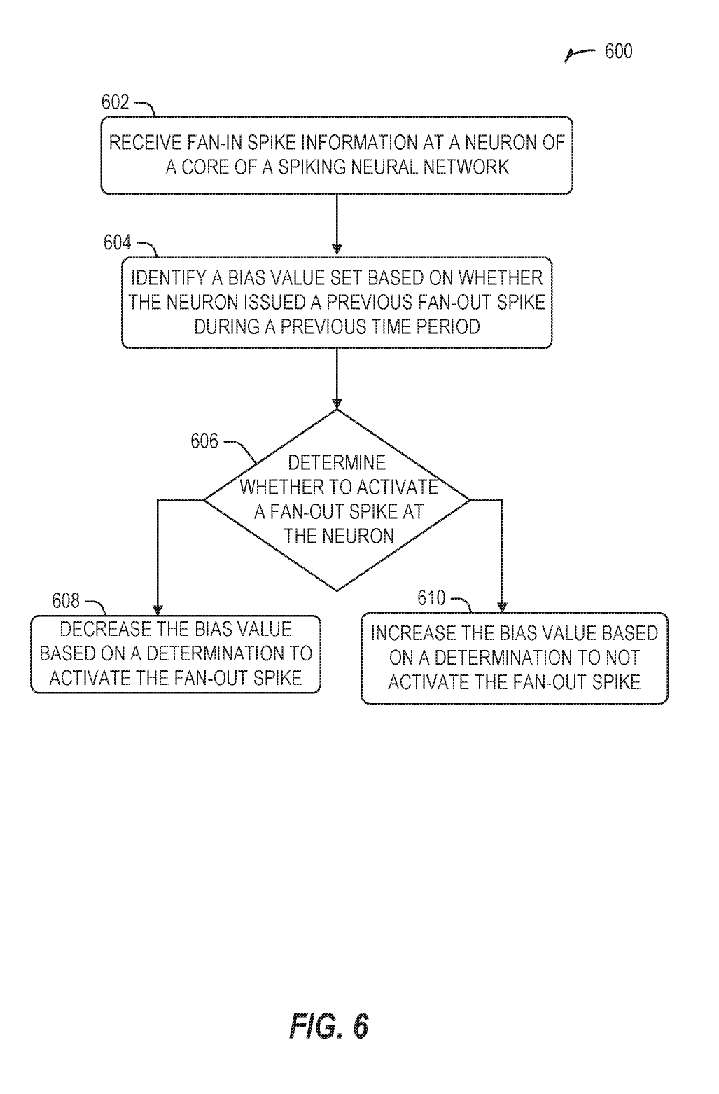

FIG. 6 illustrates a flowchart showing a technique 600 for homeostatic plasticity control in a spiking neural network in accordance with some embodiments. In an example, the spiking neural network may be a leaky neuron model spiking neural network. The technique 600 includes an operation 602 to receive, at a neuron of a core of the spiking neural network, fan-in spike information. The technique 600 includes an operation 604 to identify a bias value set based on whether the neuron issued a previous fan-out spike during a previous time period. The bias value may be unique to the neuron and not shared with other neurons on the core.

The technique 600 includes a decision operation 606 to determine whether to activate a fan-out spike at the neuron, based at least in part on the fan-in spike information and the bias value. The technique 600 includes an operation 608 to decrease the bias value based on a determination to activate the fan-out spike. The technique 600 includes an operation 610 to increase the bias value based on a determination to not activate the fan-out spike. In an example, a decrease in the bias value results in a lower likelihood of activation of a future fan-out spike during a future time period and an increase in the bias value results in a higher likelihood of activation of the future fan-out spike during the future time period. In an example, operations 608 or 610 may include shifting an activation function of the neuron. The bias value may be increased or decreased based on information found in a look-up table (e.g., B_{update} or B′_{update} from FIGS. 4-5).

Operations 608 or 610 may include adding or subtracting a bias-update value to the bias value, based on whether a pseudo-random number is equal to a preset threshold. In an example, the pseudo-random number is a deterministic pseudo-random number generated by a linear feedback shift register (e.g., 2-bit, 4-bit, 8-bit, etc.). The linear feedback shift register may be shared by the neuron with at least one other neuron (e.g., across a core). In another example, operations 608 or 610 may include adding or subtracting a bias-update value, based on whether a pseudo-random number is greater or less than a preset threshold.

The technique 600 may include an operation to perform a bounds-check to determine whether an increase or decrease from operations 608 or 610 result in a bias value outside a specified range (e.g., for an 8-bit system, within −128 to 127). The technique 600 may be performed while training the neuron of the spiking neural network. The bias value may be set or saved in memory of the neuron, such as when training is completed. In an example, the bias value is learned in order to match a desired spike rate.

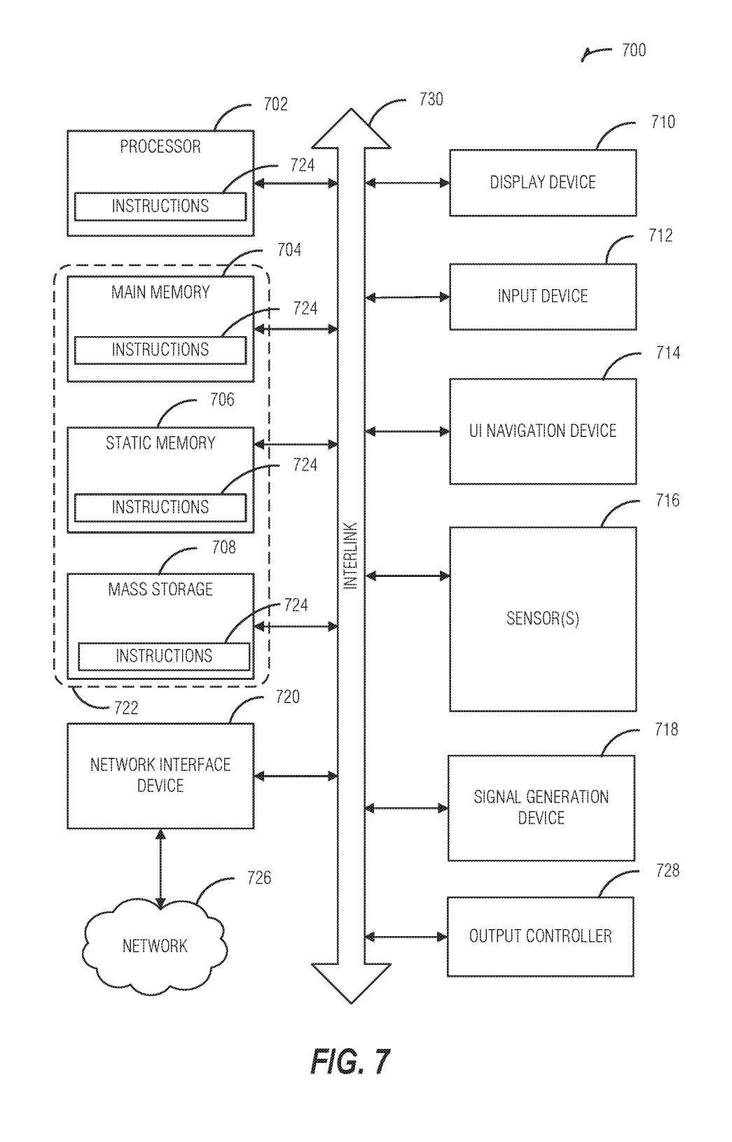

FIG. 7 illustrates a block diagram of an example machine 700 upon which any one or more of the techniques (e.g., methodologies) discussed herein may perform. Examples, as described herein, may include, or may operate by, logic or a number of components, or mechanisms in the machine 700. Circuitry (e.g., processing circuitry) is a collection of circuits implemented in tangible entities of the machine 700 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 700 follow. A neuron (e.g., as described with respect to FIGS. 1-6) may be used to implement aspects of the machine 700.

In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 700 may include a hardware processor 702 (e.g., a central processing unit (CPU), a graphics processing unit (GPU), a hardware processor core, or any combination thereof), a main memory 704, a static memory (e.g., memory or storage for firmware, microcode, a basic-input-output (BIOS), unified extensible firmware interface (UEFI), etc.) 706, and storage 708 (e.g., hard drive, tape drive, flash storage, or other block devices) some or all of which may communicate with each other via an interlink (e.g., bus) 730. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 708, a signal generation device 718 (e.g., a speaker), a network interface device 720, and one or more sensors 716, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 702, the main memory 704, the static memory 706, or the storage 708 may be, or include, a machine readable medium 722 on which is stored one or more sets of data structures or instructions 724 (e.g., software) embodying or utilized by any one or more of the techniques or functions described herein. The instructions 724 may also reside, completely or at least partially, within any of registers of the processor 702, the main memory 704, the static memory 706, or the storage 708 during execution thereof by the machine 700. In an example, one or any combination of the hardware processor 702, the main memory 704, the static memory 706, or the storage 708 may constitute the machine readable media 722. While the machine readable medium 722 is illustrated as a single medium, the term “machine readable medium” may include a single medium or multiple media (e.g., a centralized or distributed database, or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may be further transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software. A transmission medium is a machine readable medium.

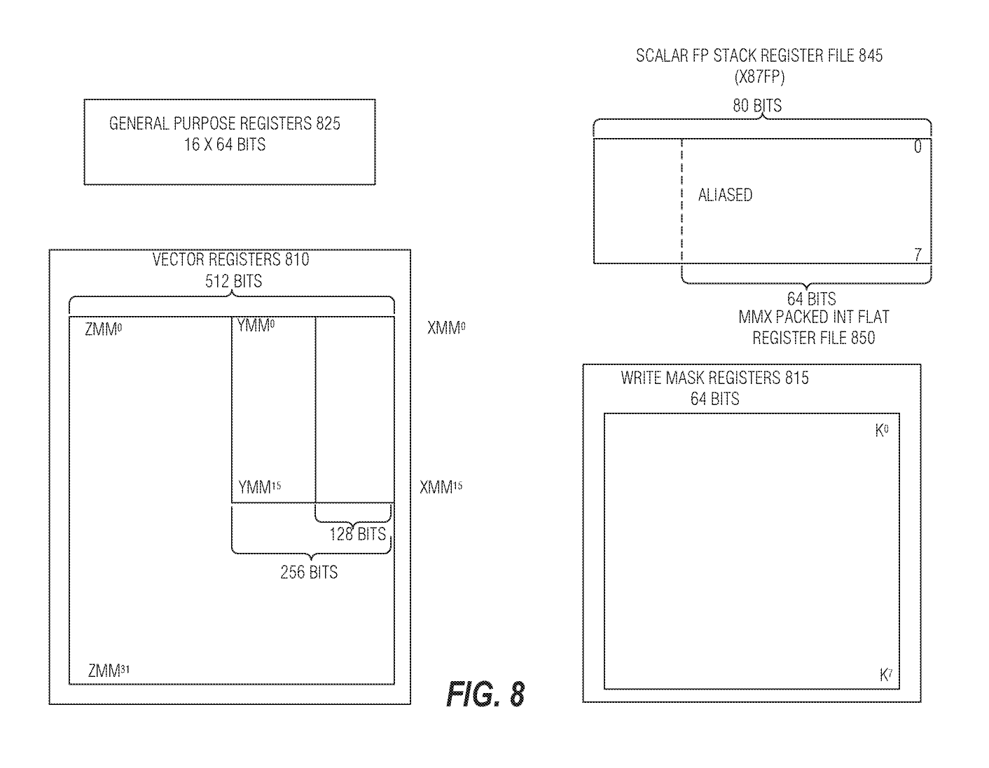

FIGS. 8 through 17 illustrate several additional examples of hardware structures or implementations that may be used to implement computer hardware. A neuron (e.g., as described with respect to FIGS. 1-6) may be used to implement or configured based on aspects of the hardware structures or implementations described with respect to FIGS. 8-17.

FIG. 8 is a block diagram of a register architecture 800 according to one embodiment of the invention. In the embodiment illustrated, there are 32 vector registers 810 that are 512 bits wide; these registers are referenced as zmm0 through zmm31. The lower order 256 bits of the lower 16 zmm registers are overlaid on registers ymm0-16. The lower order 128 bits of the lower 16 zmm registers (the lower order 128 bits of the ymm registers) are overlaid on registers xmm0-15.

Write mask registers 815—in the embodiment illustrated, there are 8 write mask registers (k0 through k7), each 64 bits in size. In an alternate embodiment, the write mask registers 815 are 16 bits in size. As previously described, in one embodiment of the invention, the vector mask register k0 cannot be used as a write mask; when the encoding that would normally indicate k0 is used for a write mask, it selects a hardwired write mask of 0xFFFF, effectively disabling write masking for that instruction.

General-purpose registers 825—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

[Scalar floating point stack register file (x87 stack) 845, on which is aliased the MMX packed integer flat register file 850—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments of the invention may use wider or narrower registers. Additionally, alternative embodiments of the invention may use more, less, or different register files and registers.

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

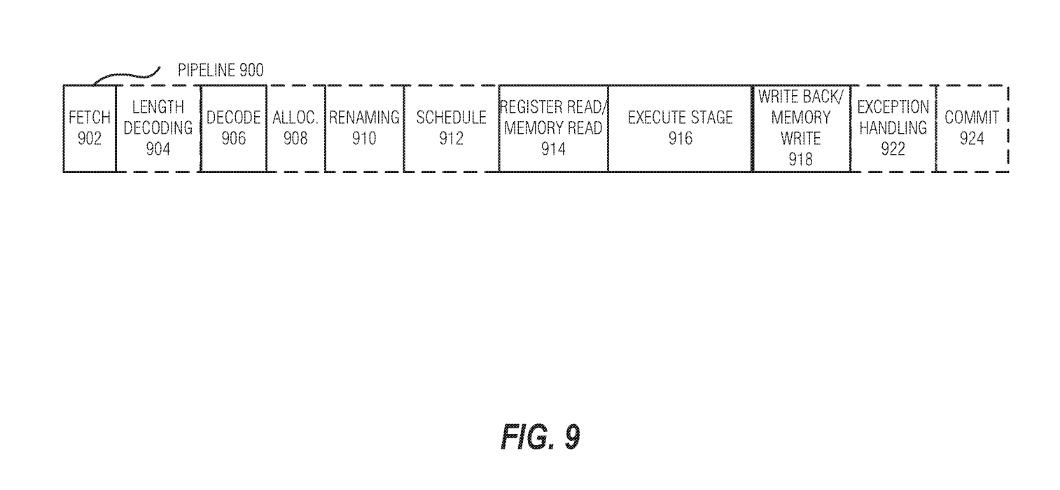

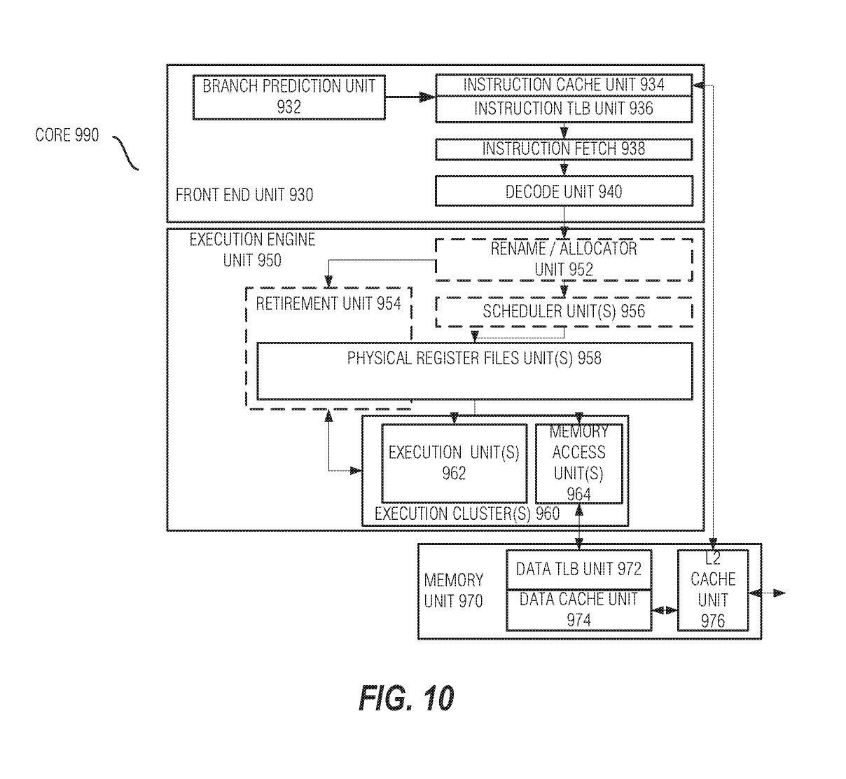

FIG. 9 is a block diagram illustrating both an exemplary in-order pipeline and an exemplary register renaming, out-of-order issue/execution pipeline according to embodiments of the invention. FIG. 10 is a block diagram illustrating both an exemplary embodiment of an in-order architecture core and an exemplary register renaming, out-of-order issue/execution architecture core to be included in a processor according to embodiments of the invention. The solid lined boxes in FIG. 9-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 9, a processor pipeline 900 includes a fetch stage 902, a length decode stage 904, a decode stage 906, an allocation stage 908, a renaming stage 910, a scheduling (also known as a dispatch or issue) stage 912, a register read/memory read stage 914, an execute stage 916, a write back/memory write stage 918, an exception handling stage 922, and a commit stage 924.

FIG. 10 shows processor core 990 including a front end unit 930 coupled to an execution engine unit 950, and both are coupled to a memory unit 970. The core 990 may be a reduced instruction set computing (RISC) core, a complex instruction set computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit 930 includes a branch prediction unit 932 coupled to an instruction cache unit 934, which is coupled to an instruction translation lookaside buffer (TLB) 936, which is coupled to an instruction fetch unit 938, which is coupled to a decode unit 940. The decode unit 940 (or decoder) may decode instructions, and generate as an output one or more micro-operations, microcode entry points, microinstructions, other instructions, or other control signals, which are decoded from, or which otherwise reflect, or are derived from, the original instructions. The decode unit 940 may be implemented using various different mechanisms. Examples of suitable mechanisms include, but are not limited to, look-up tables, hardware implementations, programmable logic arrays (PLAs), microcode read only memories (ROMs), etc. In one embodiment, the core 990 includes a microcode ROM or other medium that stores microcode for certain macroinstructions (e.g., in decode unit 940 or otherwise within the front end unit 930). The decode unit 940 is coupled to a rename/allocator unit 952 in the execution engine unit 950.

The execution engine unit 950 includes the rename/allocator unit 952 coupled to a retirement unit 954 and a set of one or more scheduler unit(s) 956. The scheduler unit(s) 956 represents any number of different schedulers, including reservations stations, central instruction window, etc. The scheduler unit(s) 956 is coupled to the physical register file(s) unit(s) 958. Each of the physical register file(s) units 958 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 958 comprises a vector registers unit, a write mask registers unit, and a scalar registers unit. These register units may provide architectural vector registers, vector mask registers, and general purpose registers. The physical register file(s) unit(s) 958 is overlapped by the retirement unit 954 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 954 and the physical register file(s) unit(s) 958 are coupled to the execution cluster(s) 960. The execution cluster(s) 960 includes a set of one or more execution units 962 and a set of one or more memory access units 964. The execution units 962 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 956, physical register file(s) unit(s) 958, and execution cluster(s) 960 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 964). It should also be understood that where separate pipelines are used, one or more of these pipelines may be out-of-order issue/execution and the rest in-order.

The set of memory access units 964 is coupled to the memory unit 970, which includes a data TLB unit 972 coupled to a data cache unit 974 coupled to a level 2 (L2) cache unit 976. In one exemplary embodiment, the memory access units 964 may include a load unit, a store address unit, and a store data unit, each of which is coupled to the data TLB unit 972 in the memory unit 970. The instruction cache unit 934 is further coupled to a level 2 (L2) cache unit 976 in the memory unit 970. The L2 cache unit 976 is coupled to one or more other levels of cache and eventually to a main memory.

By way of example, the exemplary register renaming, out-of-order issue/execution core architecture may implement the pipeline 900 as follows: 1) the instruction fetch 938 performs the fetch and length decoding stages 902 and 904; 2) the decode unit 940 performs the decode stage 906; 3) the rename/allocator unit 952 performs the allocation stage 908 and renaming stage 910; 4) the scheduler unit(s) 956 performs the schedule stage 912; 5) the physical register file(s) unit(s) 958 and the memory unit 970 perform the register read/memory read stage 914; the execution cluster 960 perform the execute stage 916; 6) the memory unit 970 and the physical register file(s) unit(s) 958 perform the write back/memory write stage 918; 7) various units may be involved in the exception handling stage 922; and 8) the retirement unit 954 and the physical register file(s) unit(s) 958 perform the commit stage 924.

The core 990 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 990 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 934/974 and a shared L2 cache unit 976, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

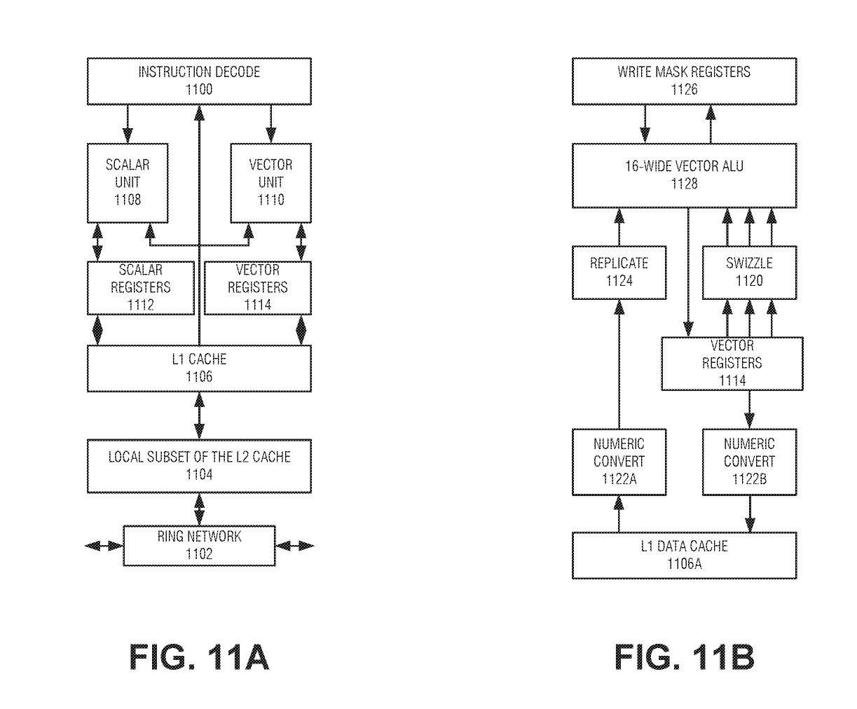

FIGS. 11A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 11A is a block diagram of a single processor core, along with its connection to the on-die interconnect network 1102 and with its local subset of the Level 2 (L2) cache 1104, according to embodiments of the invention. In one embodiment, an instruction decoder 1100 supports the x86 instruction set with a packed data instruction set extension. An L1 cache 1106 allows low-latency accesses to cache memory into the scalar and vector units. While in one embodiment (to simplify the design), a scalar unit 1108 and a vector unit 1110 use separate register sets (respectively, scalar registers 1112 and vector registers 1114) and data transferred between them is written to memory and then read back in from a level 1 (L1) cache 1106, alternative embodiments of the invention may use a different approach (e.g., use a single register set or include a communication path that allow data to be transferred between the two register files without being written and read back).

The local subset of the L2 cache 1104 is part of a global L2 cache that is divided into separate local subsets, one per processor core. Each processor core has a direct access path to its own local subset of the L2 cache 1104. Data read by a processor core is stored in its L2 cache subset 1104 and may be accessed quickly, in parallel with other processor cores accessing their own local L2 cache subsets. Data written by a processor core is stored in its own L2 cache subset 1104 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 11B is an expanded view of part of the processor core in FIG. 11A according to embodiments of the invention. FIG. 11B includes an L1 data cache 1106A part of the L1 cache 1104, as well as more detail regarding the vector unit 1110 and the vector registers 1114. Specifically, the vector unit 1110 is a 16-wide vector processing unit (VPU) (see the 16-wide ALU 1128), which executes one or more of integer, single-precision float, and double-precision float instructions. The VPU supports swizzling the register inputs with swizzle unit 1120, numeric conversion with numeric convert units 1122A-B, and replication with replication unit 1124 on the memory input. Write mask registers 1126 allow predicating resulting vector writes.

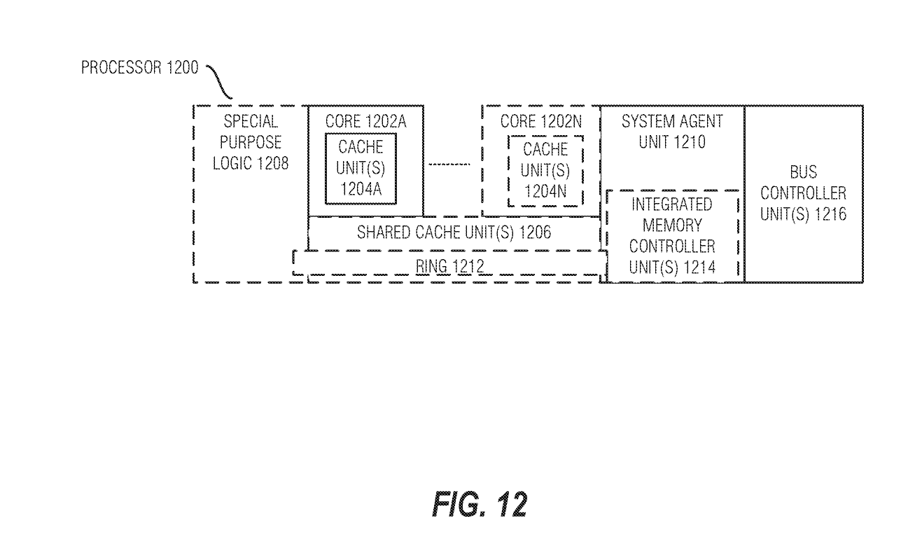

FIG. 12 is a block diagram of a processor 1200 that may have more than one core, may have an integrated memory controller, and may have integrated graphics according to embodiments of the invention. The solid lined boxes in FIG. 12 illustrate a processor 1200 with a single core 1202A, a system agent 1210, a set of one or more bus controller units 1216, while the optional addition of the dashed lined boxes illustrates an alternative processor 1200 with multiple cores 1202A-N, a set of one or more integrated memory controller unit(s) 1214 in the system agent unit 1210, and special purpose logic 1208.

Thus, different implementations of the processor 1200 may include: 1) a CPU with the special purpose logic 1208 being integrated graphics and/or scientific (throughput) logic (which may include one or more cores), and the cores 1202A-N being one or more general purpose cores (e.g., general purpose in-order cores, general purpose out-of-order cores, a combination of the two); 2) a coprocessor with the cores 1202A-N being a large number of special purpose cores intended primarily for graphics and/or scientific (throughput); and 3) a coprocessor with the cores 1202A-N being a large number of general purpose in-order cores. Thus, the processor 1200 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1200 may be a part of and/or may be implemented on one or more substrates using any of a number of process technologies, such as, for example, BiCMOS, CMOS, or NMOS.

The memory hierarchy includes one or more levels of cache 1204A-N within the cores, a set or one or more shared cache units 1206, and external memory (not shown) coupled to the set of integrated memory controller units 1214. The set of shared cache units 1206 may include one or more mid-level caches, such as level 2 (L2), level 3 (L3), level 4 (L4), or other levels of cache, a last level cache (LLC), and/or combinations thereof. While in one embodiment a ring based interconnect unit 1212 interconnects the integrated graphics logic 1208, the set of shared cache units 1206, and the system agent unit 1210/integrated memory controller unit(s) 1214, alternative embodiments may use any number of well-known techniques for interconnecting such units. In one embodiment, coherency is maintained between one or more cache units 1206 and cores 1202A-N.

In some embodiments, one or more of the cores 1202A-N are capable of multi-threading. The system agent 1210 includes those components coordinating and operating cores 1202A-N. The system agent unit 1210 may include for example a power control unit (PCU) and a display unit. The PCU may be or include logic and components needed for regulating the power state of the cores 1202A-N and the integrated graphics logic 1208. The display unit is for driving one or more externally connected displays.

The cores 1202A-N may be homogenous or heterogeneous in terms of architecture instruction set; that is, two or more of the cores 1202A-N may be capable of execution the same instruction set, while others may be capable of executing only a subset of that instruction set or a different instruction set.

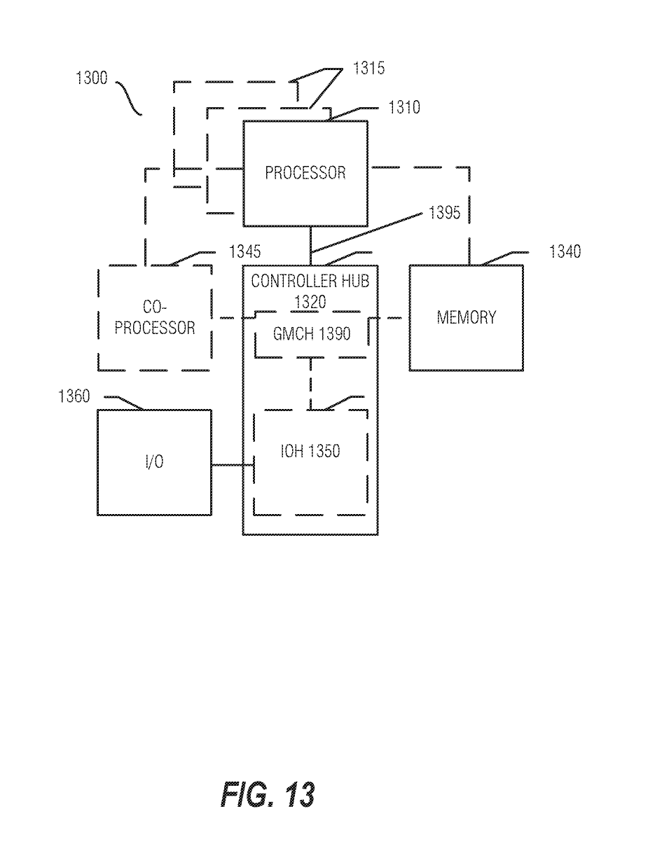

FIGS. 13-16 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 13, shown is a block diagram of a system 1300 in accordance with one embodiment of the present invention. The system 1300 may include one or more processors 1310, 1315, which are coupled to a controller hub 1320. In one embodiment the controller hub 1320 includes a graphics memory controller hub (GMCH) 1390 and an Input/Output Hub (IOH) 1350 (which may be on separate chips); the GMCH 1390 includes memory and graphics controllers to which are coupled memory 1340 and a coprocessor 1345; the IOH 1350 is couples input/output (I/O) devices 1360 to the GMCH 1390. Alternatively, one or both of the memory and graphics controllers are integrated within the processor (as described herein), the memory 1340 and the coprocessor 1345 are coupled directly to the processor 1310, and the controller hub 1320 in a single chip with the IOH 1350.

The optional nature of additional processors 1315 is denoted in FIG. 13 with broken lines. Each processor 1310, 1315 may include one or more of the processing cores described herein and may be some version of the processor 1200.

The memory 1340 may be, for example, dynamic random access memory (DRAM), phase change memory (PCM), or a combination of the two. For at least one embodiment, the controller hub 1320 communicates with the processor(s) 1310, 1315 via a multi-drop bus, such as a frontside bus (FSB), point-to-point interface such as QuickPath Interconnect (QPI), or similar connection 1395.

In one embodiment, the coprocessor 1345 is a special-purpose processor, such as, for example, a high-throughput MIC processor, a network or communication processor, compression engine, graphics processor, GPGPU, embedded processor, or the like. In one embodiment, controller hub 1320 may include an integrated graphics accelerator.

There may be a variety of differences between the physical resources 1310, 1315 in terms of a spectrum of metrics of merit including architectural, microarchitectural, thermal, power consumption characteristics, and the like.

In one embodiment, the processor 1310 executes instructions that control data processing operations of a general type. Embedded within the instructions may be coprocessor instructions. The processor 1310 recognizes these coprocessor instructions as being of a type that should be executed by the attached coprocessor 1345. Accordingly, the processor 1310 issues these coprocessor instructions (or control signals representing coprocessor instructions) on a coprocessor bus or other interconnect, to coprocessor 1345. Coprocessor(s) 1345 accept and execute the received coprocessor instructions.

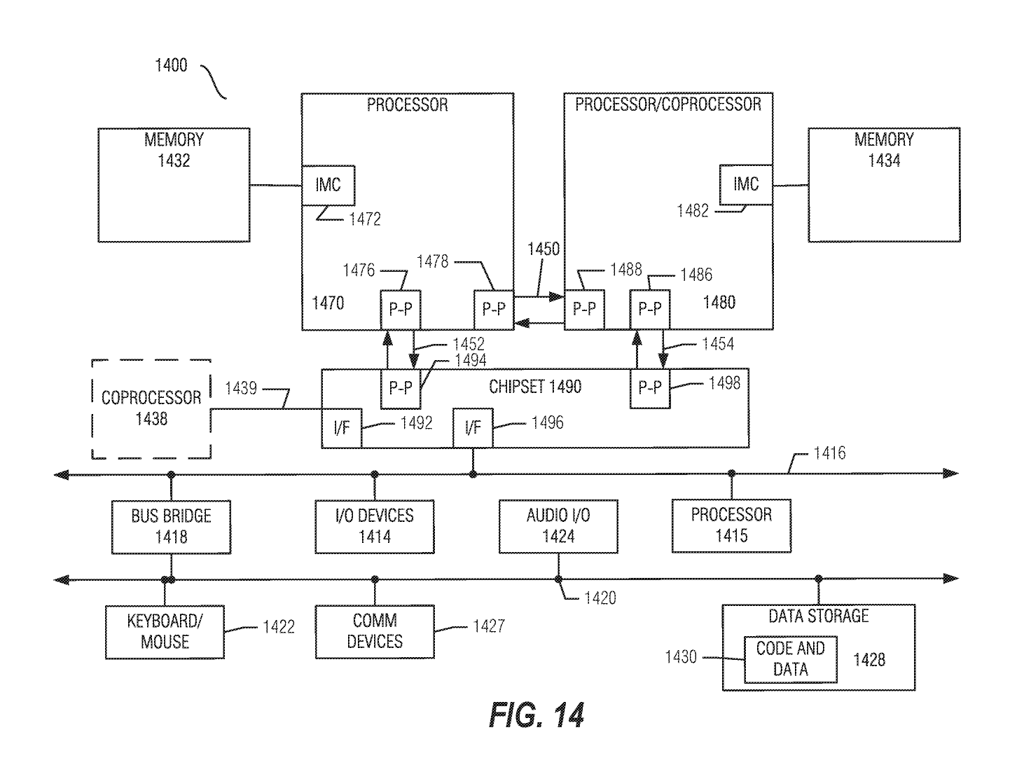

Referring now to FIG. 14, shown is a block diagram of a first more specific exemplary system 1400 in accordance with an embodiment of the present invention. As shown in FIG. 14, multiprocessor system 1400 is a point-to-point interconnect system, and includes a first processor 1470 and a second processor 1480 coupled via a point-to-point interconnect 1450. Each of processors 1470 and 1480 may be some version of the processor 1200. In one embodiment of the invention, processors 1470 and 1480 are respectively processors 1310 and 1315, while coprocessor 1438 is coprocessor 1345. In another embodiment, processors 1470 and 1480 are respectively processor 1310 coprocessor 1345.

Processors 1470 and 1480 are shown including integrated memory controller (IMC) units 1472 and 1482, respectively. Processor 1470 also includes as part of its bus controller units point-to-point (P-P) interfaces 1476 and 1478; similarly, second processor 1480 includes P-P interfaces 1486 and 1488. Processors 1470, 1480 may exchange information via a point-to-point (P-P) interface 1450 using P-P interface circuits 1478, 1488. As shown in FIG. 14. IMCs 1472 and 1482 couple the processors to respective memories, namely a memory 1432 and a memory 1434, which may be portions of main memory locally attached to the respective processors.

Processors 1470, 1480 may each exchange information with a chipset 1490 via individual P-P interfaces 1452, 1454 using point to point interface circuits 1476, 1494, 1486, 1498. Chipset 1490 may optionally exchange information with the coprocessor 1438 via a high-performance interface 1439. In one embodiment, the coprocessor 1438 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1490 may be coupled to a first bus 1416 via an interface 1496. In one embodiment, first bus 1416 may be a Peripheral Component Interconnect (PCI) bus, or a bus such as a PCI Express bus or another third generation I/O interconnect bus, although the scope of the present invention is not so limited.

As shown in FIG. 14, various I/O devices 1414 may be coupled to first bus 1416, along with a bus bridge 1418 which couples first bus 1416 to a second bus 1420. In one embodiment, one or more additional processor(s) 1415, such as coprocessors, high-throughput MIC processors, GPGPU's, accelerators (such as, e.g., graphics accelerators or digital signal processing (DSP) units), field programmable gate arrays, or any other processor, are coupled to first bus 1416. In one embodiment, second bus 1420 may be a low pin count (LPC) bus. Various devices may be coupled to a second bus 1420 including, for example, a keyboard and/or mouse 1422, communication devices 1427 and a storage unit 1428 such as a disk drive or other mass storage device which may include instructions/code and data 1430, in one embodiment. Further, an audio I/O 1424 may be coupled to the second bus 1420. Note that other architectures are possible. For example, instead of the point-to-point architecture of FIG. 14, a system may implement a multi-drop bus or other such architecture.

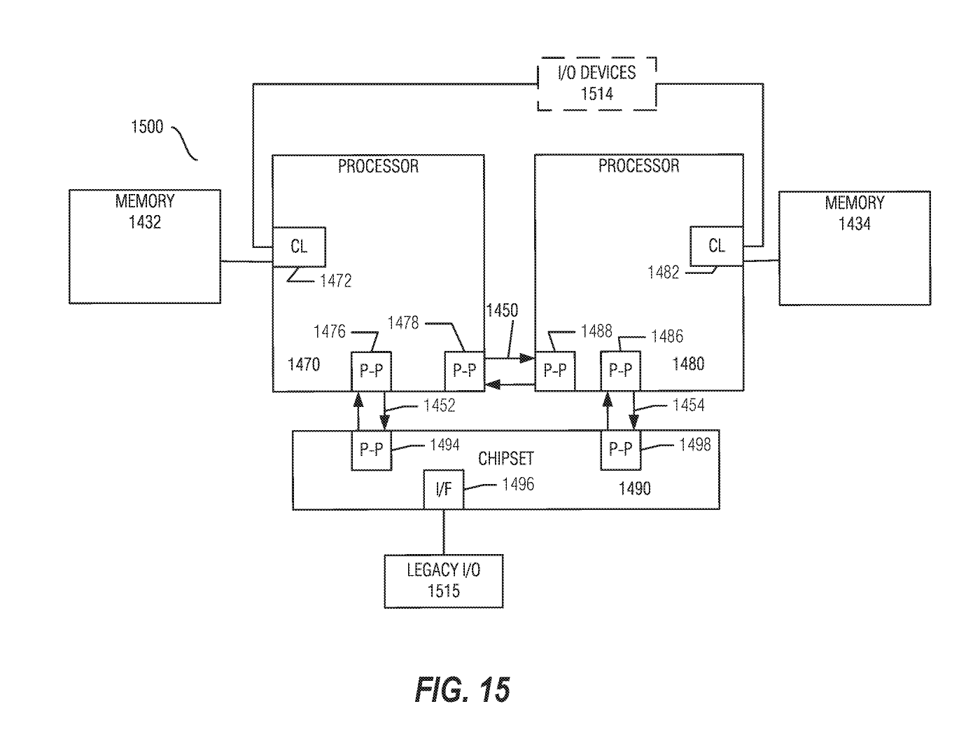

Referring now to FIG. 15, shown is a block diagram of a second more specific exemplary system 1500 in accordance with an embodiment of the present invention. Like elements in FIGS. 14 and 15 bear like reference numerals, and certain aspects of FIG. 14 have been omitted from FIG. 15 in order to avoid obscuring other aspects of FIG. 15.

FIG. 15 illustrates that the processors 1470, 1480 may include integrated memory and I/O control logic (“CL”) 1472 and 1482, respectively. Thus, the CL 1472, 1482 include integrated memory controller units and include I/O control logic. FIG. 15 illustrates that not only are the memories 1432, 1434 coupled to the CL 1472, 1482, but also that I/O devices 1514 are also coupled to the control logic 1472, 1482. Legacy I/O devices 1515 are coupled to the chipset 1490.

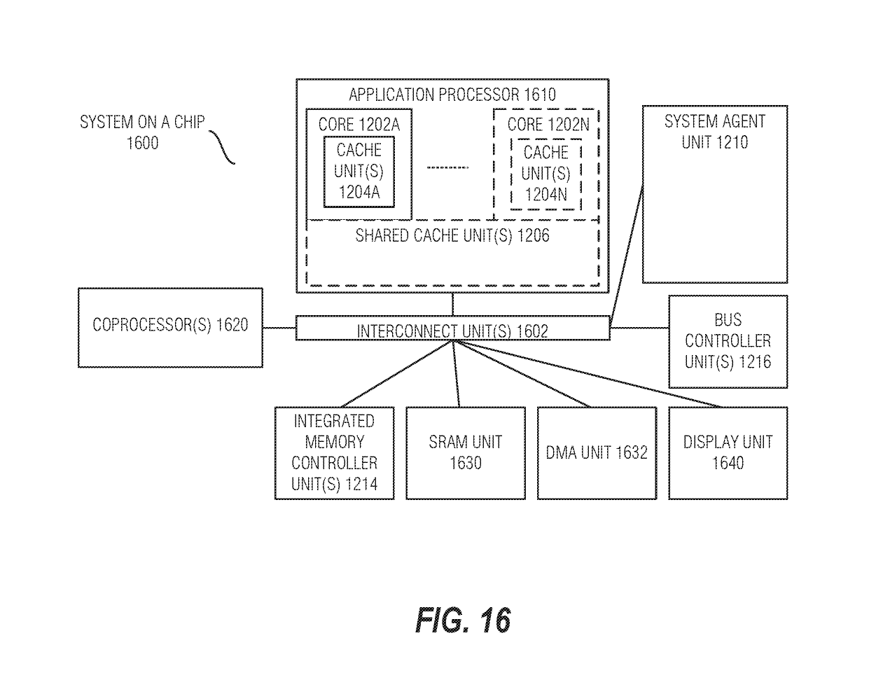

Referring now to FIG. 16, shown is a block diagram of a SoC 1600 in accordance with an embodiment of the present invention. Similar elements in FIG. 12 bear like reference numerals. Also, dashed lined boxes are optional features on more advanced SoCs. In FIG. 16, an interconnect unit(s) 1602 is coupled to: an application processor 1610 which includes a set of one or more cores 202A-N and shared cache unit(s) 1206; a system agent unit 1210; a bus controller unit(s) 1216; an integrated memory controller unit(s) 1214; a set or one or more coprocessors 1620 which may include integrated graphics logic, an image processor, an audio processor, and a video processor; an static random access memory (SRAM) unit 1630; a direct memory access (DMA) unit 1632; and a display unit 1640 for coupling to one or more external displays. In one embodiment, the coprocessor(s) 1620 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1430 illustrated in FIG. 14, may be applied to input instructions to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

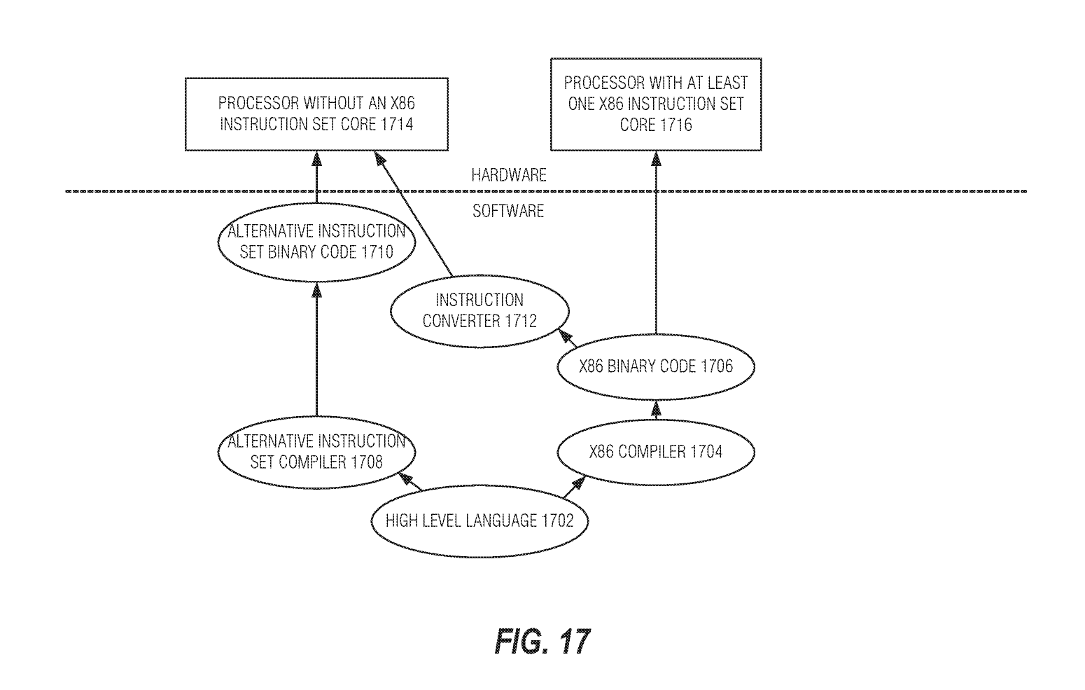

FIG. 17 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 17 shows a program in a high level language 1702 may be compiled using an x86 compiler 1704 to generate x86 binary code 1706 that may be natively executed by a processor with at least one x86 instruction set core 1716. The processor with at least one x86 instruction set core 1716 represents any processor that may perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1704 represents a compiler that is operable to generate x86 binary code 1706 (e.g., object code) that may, with or without additional linkage processing, be executed on the processor with at least one x86 instruction set core 1716. Similarly, FIG. 17 shows the program in the high level language 1702 may be compiled using an alternative instruction set compiler 1708 to generate alternative instruction set binary code 1710 that may be natively executed by a processor without at least one x86 instruction set core 1714 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1712 is used to convert the x86 binary code 1706 into code that may be natively executed by the processor without an x86 instruction set core 1714. This converted code is not likely to be the same as the alternative instruction set binary code 1710 because an instruction converter capable of this is difficult to make; however, the converted code will accomplish the general operation and be made up of instructions from the alternative instruction set. Thus, the instruction converter 1712 represents software, firmware, hardware, or a combination thereof that, through emulation, simulation or any other process, allows a processor or other electronic device that does not have an x86 instruction set processor or core to execute the x86 binary code 1706.

### VARIOUS NOTES & EXAMPLES

Each of these non-limiting examples may stand on its own, or may be combined in various permutations or combinations with one or more of the other examples.

Example 1 is a method for homeostatic plasticity control in a spiking neural network comprising: receiving, at a neuron of a core of the spiking neural network, input spike information; determining whether to activate an output spike at the neuron based at least in part on the input spike information and a bias value, the bias value set based on whether the neuron issued a previous output spike during a previous time period and the bias value being an intrinsic property of the neuron that adjusts a membrane potential over which the output spike is produced; and updating the bias value based on whether the output spike was activated at the neuron, wherein: in accordance with a determination to activate the output spike, the bias value is decreased; and in accordance with a determination to not activate the output spike, the bias value is increased.

In Example 2, the subject matter of Example 1 includes, wherein a decrease in the bias value results in a lower likelihood of activation of a future output spike during a future time period and an increase in the bias value results in a higher likelihood of activation of the future output spike during the future time period.

In Example 3, the subject matter of Examples 1-2 includes, wherein updating the bias value includes shifting an activation function of the neuron.

In Example 4, the subject matter of Examples 1-3 includes, wherein the bias value is increased or decreased based on information found in a look-up table.

In Example 5, the subject matter of Examples 1-4 includes, wherein the method is performed while training the neuron of the spiking neural network and the bias value is set and saved in memory of the neuron when training is completed.

In Example 6, the subject matter of Example 5 includes, wherein the saved bias value provides a desired output spike rate from the neuron.

In Example 7, the subject matter of Examples 1-6 includes, wherein updating the bias value includes adding or subtracting a bias-update value, based on whether a pseudo-random number is equal to a preset threshold.

In Example 8, the subject matter of Example 7 includes, wherein the pseudo-random number is a deterministic pseudo-random number generated by a linear feedback shift register.

In Example 9, the subject matter of Example 8 includes, wherein the linear feedback shift register is shared by the neuron with at least one other neuron.

In Example 10, the subject matter of Examples 1-9 includes, wherein updating the bias value includes adding or subtracting a bias-update value, based on whether a pseudo-random number is greater or less than a preset threshold.

In Example 11, the subject matter of Examples 1-10 includes, wherein updating the bias value includes performing a bounds check after increasing or decreasing the bias value to ensure that the bias value remains within a predetermined range.

In Example 12, the subject matter of Examples 1-11 includes, wherein the bias value is unique to the neuron and not shared with other neurons on the core.

In Example 13, the subject matter of Examples 1-12 includes, wherein the spiking neural network is a leaky neuron model.

Example 14 is at least one machine-readable medium including instructions for operation of a computing system, which when executed by a machine, causes the machine to perform operations of any of the methods of Examples 1-13.

Example 15 is an apparatus comprising means for performing any of the methods of Examples 1-13.

Example 16 is a neuron of a core of a spiking neural network under homeostatic plasticity control comprising: neuro-processing circuitry to: receive input spike information; determine whether to activate an output spike at the neuron based at least in part on the input spike information and a bias value, the bias value set based on whether the neuron issued a previous output spike during a previous time period and the bias value being an intrinsic property of the neuron that adjusts a membrane potential over which the output spike is produced; and update the bias value based on whether the output spike was activated at the neuron, wherein: in accordance with a determination to activate the output spike, the bias value is decreased; and in accordance with a determination to not activate the output spike, the bias value is increased.

In Example 17, the subject matter of Example 16 includes, wherein a decrease in the bias value results in a lower likelihood of activation of a future output spike during a future time period and an increase in the bias value results in a higher likelihood of activation of the future output spike during the future time period.

In Example 18, the subject matter of Examples 16-17 includes, wherein to update the bias value, the neuro-processing circuitry is further to shift an activation function of the neuron.

In Example 19, the subject matter of Examples 16-18 includes, wherein the bias value is increased or decreased based on information found in a look-up table.

In Example 20, the subject matter of Examples 16-19 includes, wherein the neuro-processing circuitry is further to update the bias value during training of the neuron, and wherein the bias value is set and saved in memory of the neuron when training is completed.

In Example 21, the subject matter of Example 20 includes, wherein the updated bias value provides a desired output spike rate from the neuron.

In Example 22, the subject matter of Examples 16-21 includes, wherein to update the bias value, the neuro-processing circuitry is further to add or subtract a bias-update value, based on whether a pseudo-random number is equal to a preset threshold.

In Example 23, the subject matter of Example 22 includes, wherein the pseudo-random number is a deterministic pseudo-random number generated by a linear feedback shift register.

In Example 24, the subject matter of Example 23 includes, wherein the linear feedback shift register is shared by the neuron with at least one other neuron.

In Example 25, the subject matter of Examples 16-24 includes, wherein to update the bias value, the neuro-processing circuitry is further to add or subtract a bias-update value, based on whether a pseudo-random number is greater or less than a preset threshold.

In Example 26, the subject matter of Examples 16-25 includes, wherein to update the bias value, the neuro-processing circuitry is further to perform a bounds check after increasing or decreasing the bias value to ensure that the bias value remains within a predetermined range.

In Example 27, the subject matter of Examples 16-26 includes, wherein the bias value is unique to the neuron and not shared with other neurons on the core.

In Example 28, the subject matter of Examples 16-27 includes, wherein the spiking neural network is a leaky neuron model.

Example 29 is at least one machine readable medium including instructions for homeostatic plasticity control in a spiking neural network, wherein the instructions, when executed by neuro-processing circuitry, configure the neuro-processing circuitry to perform operations to: receive input spike information; determine whether to activate an output spike at the neuron based at least in part on the input spike information and a bias value, the bias value set based on whether the neuron issued a previous output spike during a previous time period and the bias value being an intrinsic property of the neuron that adjusts a membrane potential over which the output spike is produced; and update the bias value based on whether the output spike was activated at the neuron, wherein: in accordance with a determination to activate the output spike, the bias value is decreased; and in accordance with a determination to not activate the output spike, the bias value is increased.

In Example 30, the subject matter of Example 29 includes, wherein a decrease in the bias value results in a lower likelihood of activation of a future output spike during a future time period and an increase in the bias value results in a higher likelihood of activation of the future output spike during the future time period.

In Example 31, the subject matter of Examples 29-30 includes, wherein to update the bias value, the instructions further cause the neuro-processing circuitry to shift an activation function of the neuron.

In Example 32, the subject matter of Examples 29-31 includes, wherein the bias value is increased or decreased based on information found in a look-up table.

In Example 33, the subject matter of Examples 29-32 includes, wherein the instructions further cause the neuro-processing circuitry to update the bias value during training of the neuron, and wherein the bias value is set and saved in memory of the neuron when training is completed.

In Example 34, the subject matter of Example 33 includes, wherein the updated bias value provides a desired output spike rate from the neuron.

In Example 35, the subject matter of Examples 29-34 includes, wherein to update the bias value, the instructions further cause the neuro-processing circuitry to add or subtract a bias-update value, based on whether a pseudo-random number is equal to a preset threshold.

In Example 36, the subject matter of Example 35 includes, wherein the pseudo-random number is a deterministic pseudo-random number generated by a linear feedback shift register.

In Example 37, the subject matter of Example 36 includes, wherein the linear feedback shift register is shared by the neuron with at least one other neuron.

In Example 38, the subject matter of Examples 29-37 includes, wherein to update the bias value, the instructions further cause the neuro-processing circuitry to add or subtract a bias-update value, based on whether a pseudo-random number is greater or less than a preset threshold.

In Example 39, the subject matter of Examples 29-38 includes, wherein to update the bias value, the instructions further cause the neuro-processing circuitry to perform a bounds check after increasing or decreasing the bias value to ensure that the bias value remains within a predetermined range.

In Example 40, the subject matter of Examples 29-39 includes, wherein the bias value is unique to the neuron and not shared with other neurons on the core.

In Example 41, the subject matter of Examples 29-40 includes, wherein the spiking neural network is a leaky neuron model.

Example 42 is an apparatus for homeostatic plasticity control in a spiking neural network comprising: means for receiving, at a neuron of a core of the spiking neural network, input spike information; means for determining whether to activate an output spike at the neuron based at least in part on the input spike information and a bias value, the bias value set based on whether the neuron issued a previous output spike during a previous time period and the bias value being an intrinsic property of the neuron that adjusts a membrane potential over which the output spike is produced; and means for updating the bias value based on whether the output spike was activated at the neuron, wherein: in accordance with a determination to activate the output spike, the bias value is decreased; and in accordance with a determination to not activate the output spike, the bias value is increased.

In Example 43, the subject matter of Example 42 includes, wherein a decrease in the bias value results in a lower likelihood of activation of a future output spike during a future time period and an increase in the bias value results in a higher likelihood of activation of the future output spike during the future time period.

In Example 44, the subject matter of Examples 42-43 includes, wherein the means for updating the bias value include means for shifting an activation function of the neuron.

In Example 45, the subject matter of Examples 42-44 includes, wherein the bias value is increased or decreased based on information found in a look-up table.

In Example 46, the subject matter of Examples 42-45 includes, wherein the means for updating the bias value, include means for training the neuron of the spiking neural network and the bias value is set and saved in memory of the neuron when training is completed.

In Example 47, the subject matter of Example 46 includes, wherein the updated bias value provides a desired output spike rate from the neuron.

In Example 48, the subject matter of Examples 42-47 includes, wherein the means for updating the bias value include means for adding or subtracting a bias-update value, based on whether a pseudo-random number is equal to a preset threshold.

In Example 49, the subject matter of Example 48 includes, wherein the pseudo-random number is a deterministic pseudo-random number generated by a linear feedback shift register.

In Example 50, the subject matter of Example 49 includes, wherein the linear feedback shift register is shared by the neuron with at least one other neuron.

In Example 51, the subject matter of Examples 42-50 includes, wherein the means for updating the bias value include means for adding or subtracting a bias-update value, based on whether a pseudo-random number is greater or less than a preset threshold.

In Example 52, the subject matter of Examples 42-51 includes, wherein the means for updating the bias value include means for performing a bounds check after increasing or decreasing the bias value to ensure that the bias value remains within a predetermined range.

In Example 53, the subject matter of Examples 42-52 includes, wherein the bias value is unique to the neuron and not shared with other neurons on the core.

In Example 54, the subject matter of Examples 42-53 includes, wherein the spiking neural network is a leaky neuron model.

Example 55 is at least one machine-readable medium including instructions that, when executed by processing circuitry, cause the processing circuitry to perform operations to implement of any of Examples 1-54.

Example 56 is an apparatus comprising means to implement of any of Examples 1-54.

Example 57 is a system to implement of any of Examples 1-54.

Example 58 is a method to implement of any of Examples 1-54.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A neuron of a core of a spiking neural network under homeostatic plasticity control comprising:
neuro-processing circuitry to:
receive input spike information;
determine whether to activate an output spike at the neuron based at least in part on the input spike information and a bias value, the bias value set based on whether the neuron issued a previous output spike during a previous time period and the bias value being an intrinsic property of the neuron that adjusts a membrane potential over which the output spike is produced; and
update the bias value based on whether the output spike was activated at the neuron, wherein:
in accordance with a determination to activate the output spike, the bias value is decreased; and
in accordance with a determination to not activate the output spike, the bias value is increased.

2. The neuron of claim 1, wherein a decrease in the bias value results in a lower likelihood of activation of a future output spike during a future time period and an increase in the bias value results in a higher likelihood of activation of the future output spike during the future time period.

3. The neuron of claim 1, wherein to update the bias value, the neuro-processing circuitry is further to shift an activation function of the neuron.

4. The neuron of claim 1, wherein the bias value is increased or decreased based on information found in a look-up table.

5. The neuron of claim 1, wherein the neuro-processing circuitry is further to update the bias value during training of the neuron, and wherein the bias value is set and saved in memory of the neuron when training is completed.

6. The neuron of claim 5, wherein the updated bias value provides a desired output spike rate from the neuron.

7. The neuron of claim 1, wherein to update the bias value, the neuro-processing circuitry is further to add or subtract a bias-update value, based on whether a pseudo-random number is equal to a preset threshold.

8. The neuron of claim 7, wherein the pseudo-random number is a deterministic pseudo-random number generated by a linear feedback shift register.

9. The neuron of claim 8, wherein the linear feedback shift register is shared by the neuron with at least one other neuron.

10. The neuron of claim 1, wherein to update the bias value, the neuro-processing circuitry is further to add or subtract a bias-update value, based on whether a pseudo-random number is greater or less than a preset threshold.

11. The neuron of claim 1, wherein to update the bias value, the neuro-processing circuitry is further to perform a bounds check after increasing or decreasing the bias value to ensure that the bias value remains within a predetermined range.

12. The neuron of claim 1, wherein the bias value is unique to the neuron and not shared with other neurons on the core.

13. A method for homeostatic plasticity control in a spiking neural network comprising:
receiving, at a neuron of a core of the spiking neural network, input spike information;
determining whether to activate an output spike at the neuron based at least in part on the input spike information and a bias value, the bias value set based on whether the neuron issued a previous output spike during a previous time period and the bias value being an intrinsic property of the neuron that adjusts a membrane potential over which the output spike is produced; and
updating the bias value based on whether the output spike was activated at the neuron, wherein:
in accordance with a determination to activate the output spike, the bias value is decreased; and
in accordance with a determination to not activate the output spike, the bias value is increased.

14. The method of claim 13, wherein a decrease in the bias value results in a lower likelihood of activation of a future output spike during a future time period and an increase in the bias value results in a higher likelihood of activation of the future output spike during the future time period.

15. The method of claim 13, wherein updating the bias value includes shifting an activation function of the neuron.

16. The method of claim 13, wherein the method is performed while training the neuron of the spiking neural network and the bias value is set and saved in memory of the neuron when training is completed.

17. The method of claim 16, wherein the saved bias value provides a desired output spike rate from the neuron.

18. The method of claim 13, wherein updating the bias value includes adding or subtracting a bias-update value, based on whether a pseudo-random number is equal to a preset threshold.

19. The method of claim 18, wherein the pseudo-random number is a deterministic pseudo-random number generated by a linear feedback shift register.

20. The method of claim 19, wherein the linear feedback shift register is shared by the neuron with at least one other neuron.

21. The method of claim 13, wherein updating the bias value includes adding or subtracting a bias-update value, based on whether a pseudo-random number is greater or less than a preset threshold.

22. The method of claim 13, wherein updating the bias value includes performing a bounds check after increasing or decreasing the bias value to ensure that the bias value remains within a predetermined range.

23. At least one non-transitory machine readable medium including instructions for homeostatic plasticity control in a spiking neural network, wherein the instructions, when executed by neuro-processing circuitry, configure the neuro-processing circuitry to perform operations to:
receive input spike information;
determine whether to activate an output spike at the neuron based at least in part on the input spike information and a bias value, the bias value set based on whether the neuron issued a previous output spike during a previous time period and the bias value being an intrinsic property of the neuron that adjusts a membrane potential over which the output spike is produced; and
update the bias value based on whether the output spike was activated at the neuron, wherein:
in accordance with a determination to activate the output spike, the bias value is decreased; and
in accordance with a determination to not activate the output spike, the bias value is increased.

24. The at least one machine readable medium of claim 23, wherein a decrease in the bias value results in a lower likelihood of activation of a future output spike during a future time period and an increase in the bias value results in a higher likelihood of activation of the future output spike during the future time period.

25. The at least one machine readable medium of claim 23, wherein to update the bias value, the instructions further cause the neuro-processing circuitry to shift an activation function of the neuron.
